(19) United States
(12) Patent Application Publication
(10) Pub. No.: US 2008/0272189 A1
(43) Pub. Date: Nov. 6, 2008

(54) Amount-of-money processing apparatus and amount-of-money processing method

(76) Inventors: Keisuke Shite, Tokyo (JP); Yuji Takeda, Tokyo (JP)

Correspondence Address: BRUCE L. ADAMS, ESQ., SUITE 1231, 17 BATTERY PLACE, NEW YORK, NY, 10004, US

(21) Appl. No.: 11/799,986

(22) Filed: May 3, 2007

(51) Int. Cl. G07D 11/00

(52) U.S. Cl. 235/379

(57) ABSTRACT

In a charge terminal, the amount of money added to a money terminal (an electronic money card or the like) can be easily set up. A charge terminal is provided with a slot for inserting paper money and a reader/writer section for a non-contact IC card, and it can access the electronic money card formed from the non-contact IC card through the reader/writer section. Moreover, the charge terminal has a function for charging value on the electronic money card by the amount of money of an inserted paper money, and further stores an amount-of-money table in which ID information (hereinafter, campaign card ID) of an IC card for campaign (herein after, campaign card) is connected with the amount of money for charge, and can charge the amount of money corresponding to the campaign card ID read in the reader/writer section to the IC card.

### BACKGROUND OF THE INVENTION

1. Field of the Invention

The present invention relates to an amount-of-money processing apparatus and an amount-of-money processing method, and for example, to an apparatus and a method for writing the amount of money of money value in an electronic money card with a built-in IC chip.

2. Description of the Related Art

In recent years, settlement systems using electronic money have been introduced at retail stores, department stores, or the like, and have been increasingly widely used. In the electronic money, the money value called the value having value similar to the money, is stored in an electronic money card formed from an IC card or an IC chip incorporated in a mobile phone supporting the electronic money, and these IC chips are used as an electronic wallet.

Processing for writing the value in the IC chip or the like is called charge, and the charge can be performed by communicating the IC chip with a special-purpose terminal apparatus (hereinafter, electronic money terminal) set up in the counter of a retail store or the like, or by communicating it with an electronic money server through the Internet.

The settlement of accounts by the value can be performed by reducing the amount of money of the value stored in the IC chip by a price, and can be performed with the electronic money terminal or the electronic money server in a manner similar to that of the charge. Such an invention using the electronic money is described in the following document by the present applicant.
[Patent Document 1] Japanese Unexamined Patent Publication (Kokai) No. 2003-141428

This technology provides a fundamental configuration for circulating the money value of the electronic money by using networks or the like. The user of the electronic money can purchase goods and service based on this configuration without using cash, thereby enjoying the convenience of the electronic money.

In order that general consumers as many as possible come to use the electric money, companies undertaking electronic money business conduct various campaigns, and one of these is campaign charge. This is a service allowing the value of the fixed amount of money to be charged on a user's electronic money card, at any occasion, such as a user's new purchase of an electronic money card, the celebration of opening of a new store, a campaign period, or the like.

In this case, a person in charge stands by with cash for charge at a charge terminal for charging electronic money. After that, when a person eligible for campaign brings an electronic money card or the like, the person in charge puts cash into the charge terminal, allowing the user's IC chip to be charged.

Charge terminals used conventionally do not have a slot for inserting a coin, and therefore the charge was performed by the unit of the face value of paper money (1,000 yen/unit or the like). Accordingly, the amount of money for campaign charge could not be set up at any fractional value such as, for example, 500 yen or 300 yen, thereby being inconvenient to the campaign agency. Moreover, the person in charge must bring a plurality of paper moneys, insert these into the charge terminal each time, and retrieve and reuse the inserted paper moneys, and therefore these operations become a burden for the person in charge.

### SUMMARY OF THE INVENTION

It is therefore an object of the present invention to enable the easy setup of the amount of money to be added, in an amount-of-money processing apparatus for writing the money value constituting electronic money in a storage medium.

In order to achieve the above object, in the invention according to claim 1, there is provided an amount-of-money processing apparatus including: additional amount-of-money memory means for setting up and storing a connection between identification information and an additional amount of money; identification information inputting means for receiving an input of identification information; additional amount-of-money obtaining means for obtaining the additional amount of money corresponding to the identification information whose input was received, by using the stored connection; money terminal communicating means for communicating with a money terminal, including money information memory means for storing money information which expresses the amount of money of money value as electronic data, and amount-of-money updating means for updating the amount of money expressed by the stored money information by using amount-of-money update information; and amount-of-money update information outputting means for outputting the amount-of-money update information for updating from the amount of money of the money information stored in the money terminal being communicating to the amount of money added by the obtained additional amount of money, to the money terminal. In the invention according to claim 2, there is provided the amount-of-money processing apparatus according to claim 1, including storage medium access means for accessing a storage medium storing identification information, wherein the identification information inputting means obtains the identification information from the accessed storage medium to receive the input. In the invention according to claim 3, there is provided the amount-of-money processing apparatus according to claim 1 or 2, including password reception means for receiving an input of a password; initial value obtaining means for obtaining an initial value; and password comparison means for comparing a calculation result calculated from the obtained initial value by using a predetermined logic with the received password, wherein as a result of the comparison, when the password whose input was received and the calculation result satisfy a predetermined relation, the additional amount-of-money memory means sets up a connection between the identification information and the additional amount of money. In the invention according to claim 4, there is provided the amount-of-money processing apparatus according to claim 3, including initial value updating means for automatically updating the value of the initial value obtained by the initial value obtaining means, according to a predetermined rule. In the invention according to claim 5, in a computer provided with additional amount-of-money memory means, identification information inputting means, additional amount-of-money obtaining means, money terminal communicating means, and amount-of-money update information outputting means, there is provided an amount-of-money processing method including: by the additional amount-of-money memory means, setting up and storing a connection between identification information and an additional amount of money; by the identification information inputting means, receiving an input of the identification information; by the additional amount-of-money obtaining means, obtaining the additional amount of money corresponding to the identification information whose input was received, by using the stored connection; by the money terminal communicating means, communicating with a money terminal including money information memory means for storing money information which expresses the amount of money of money value as electronic data, and amount-of-money updating means for updating the amount of money expressed by the stored money information by using amount-of-money update information; and by the amount-of-money update information outputting means, outputting the amount-of-money update information for updating from the amount of money of the money information stored in the money terminal being communicating to the amount of money added by the obtained additional amount of money, to the money terminal.

According to the present invention, an amount of money to be added can be easily set up in an amount-of-money processing apparatus for writing money value constituting electronic money in a storage medium.

### BRIEF DESCRIPTION OF THE DRAWINGS

FIG. 1 is a block diagram illustrating the function of a campaign card and an electronic money card;

FIG. 2 is a block diagram illustrating an example of the hardware configuration of a non-contact IC card;

FIG. 3 is a diagram illustrating the appearance of a charge terminal;

FIG. 4 is a diagram illustrating the configuration of a display operation section;

FIG. 5 is a diagram illustrating an example of the logical constitution of an amount-of-money table;

FIG. 6 is a diagram illustrating an example of the hardware configuration of a charge terminal;

FIG. 7 is a flow chart illustrating the procedure of campaign charge performed by a charge terminal;

FIG. 8 is a block diagram illustrating an example of the functional configuration of a mobile phone;

FIG. 9 is a diagram illustrating the usage patterns of an electronic money card or the like; and

FIG. 10 is a block diagram illustrating a modification.

### DETAILED DESCRIPTION OF THE PREFERRED EMBODIMENTS

### (1) Outline of an Embodiment

A charge terminal is provided with an inserting slot of paper money and a reader/writer section for a non-contact IC card, and can access the electronic money card formed from the non-contact IC card through the reader/writer section.

The charge terminal has a usual function for charging value on an electronic money card by the face amount of the inserted paper money, further stores an amount-of-money table in which the ID information of an IC card for campaign (hereinafter, campaign card) (hereinafter, campaign card ID) is connected with the amount of money for charge, and has a function of charging the amount of money corresponding to campaign card ID read in the reader/writer section to the IC card.

By the charge terminal configured in this manner, campaign charge is performed in the following procedure. When a person eligible for campaign brings an electronic money card, a person in charge usually changes a charge terminal from the normal mode to the campaign mode by the campaign card corresponding to the campaign amount of money. This is performed by setting the campaign card to the reader/writer section.

The setting of the campaign card causes the charge terminal to be automatically changed from the normal mode to the campaign mode, and the charging by the electronic money card of the person eligible for campaign causes it to be automatically returned to the normal mode. In the present embodiment, it is changed to the campaign mode each time in this manner.

When the campaign card is set, the charge terminal reads the campaign card ID in this campaign card to obtain the corresponding amount of money for charge from the amount-of-money table. The person in charge then removes the campaign card from the reader/writer section, and directs a user to set the electronic money card to the reader/writer section.

When the user sets the electronic money card to the reader/writer section according to the directions, the charge terminal charges the value of the amount of money obtained previously on this electronic money card. In this way, the user can charge the value by the campaign on the electronic money card.

The amount of money of the amount-of-money table can be set up at any fractional amount of money, for example, 500 yen or the like, which cannot be performed by the face value of paper money. Accordingly, the campaign agency can set up the campaign amount of money without being restricted to the amount of money of paper money. Moreover, since the charge is prepared only by setting the campaign card to the reader/writer section, there is no need for troublesome processing including preparing a plurality of paper moneys for the campaign, inserting these, and further retrieving these.

Moreover, in order to strengthen security, the charge terminal is configured to request the input of a password when an amount-of-money table is set up. This password is dynamically generated by calculating using predetermined logic. Meanwhile, the program for computing a password by using the same logic is provided to a campaign agency from an electronic money company, and the campaign agency can obtain a password of the day by this program.

### (2) Details of the Embodiment

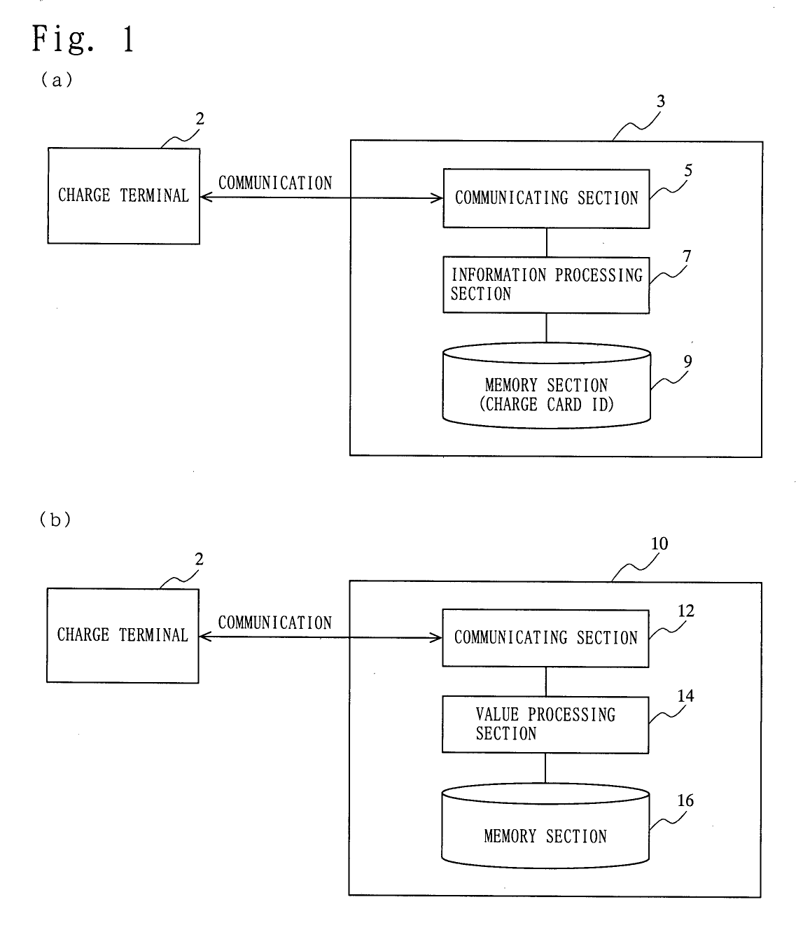

First, the function of a campaign card and an electronic money card will be described using FIG. 1. FIG. 1A is a block diagram conceptually showing the function of a campaign card. A campaign card 3 is formed from a non-contact IC card which will be described later, and can perform short-range wireless communications through the reader/writer section of a charge terminal 2.

The campaign card 3 is composed of a communicating section 5, an information processing section 7, a memory section 9, and the like. The communicating section 5 is a function section for performing wireless communications with the charge terminal 2, and is composed of an antenna, a high frequency circuit, and the like. The campaign card 3 can receive a command, data, or the like from the charge terminal 2 through the communicating section 5, and can conversely transmit data or the like to the charge terminal 2. In other words, the campaign card 3 can perform bi-directional wireless communications with the charge terminal 2 by using the communicating section 5. It should be noted that an electric power for driving the campaign card 3 is supplied from the charge terminal 2 by radio.

The information processing section 7 executes the command or the like inputted from the charge terminal 2 to perform various kinds of information processing. For example, when the transmission request of the campaign card ID is received from the charge terminal 2, the information processing section 7 reads the campaign card ID from the memory section 9 and transmits it to the charge terminal 2.

In the memory section 9, a program describing the information processing executed by the information processing section 7, data, and the like are stored. Moreover, in the memory section 9, the charge card ID is stored to be used to provide the charge card ID for the charge terminal 2.

FIG. 1B is a block diagram conceptually showing the function of the electronic money card. An electronic money card 10 is also formed from a non-contact IC card, as will be described later, and can perform short-range wireless communications through the reader/writer section of the charge terminal 2.

The electronic money card 10 is composed of a communicating section 12, a value processing section 14, a memory section 16, and the like. The communicating section 12 is a function section for controlling wireless communications with the charge terminal 2 in a manner similar to that of the communicating section 5.

According to the instructions from the charge terminal 2 or other communication destinations, the value processing section 14 outputs the ID information of the electronic money card (hereinafter, electronic money card ID) and the value balance of the electronic money card, or receives the update information of the amount of money from an external communication destination to update the value balance stored in the memory section 16. The communication destinations other than the charge terminal 2 include electronic money servers, electronic money terminals installed in stores, or the like, which will be described later.

In the memory section 16, various data such as the value balance or the log data of dealings, programs causing the value processing section 14 to perform the value processing function, or the like are stored.

As a method of updating the value balance, there are two possible methods: one is to calculate the balance by the electronic money card 10, and another is to calculate the balance by the charge terminal 2 or the other communication destinations. In the former, a command is inputted into the electronic money card 10 to perform arithmetic processing in the electronic money card 10, and therefore this command produces the update information of the amount of money. Meanwhile, in the latter, the value balance is inputted into the electronic money card 10 to rewrite the balance, and the inputted value balance produces the update information of the amount of money. Furthermore, these can be combined depending on whether addition or subtraction, and a system design determines which system should be adopted.

In a way described above, the electronic money card 10 can increase or decrease the amount of the value stored inside, and by making it correspond with money, it can be circulated as the exchange value similar to the money. Moreover, as described above, the electronic money card 10 constitutes a money terminal which is provided with money information memory means (memory section 16) for storing the value which is money information expressing the amount of money of money value as electronic data, and amount-of-money updating means (value processing section 14) for updating the amount of money expressed by the stored money information by using the amount-of-money update information.

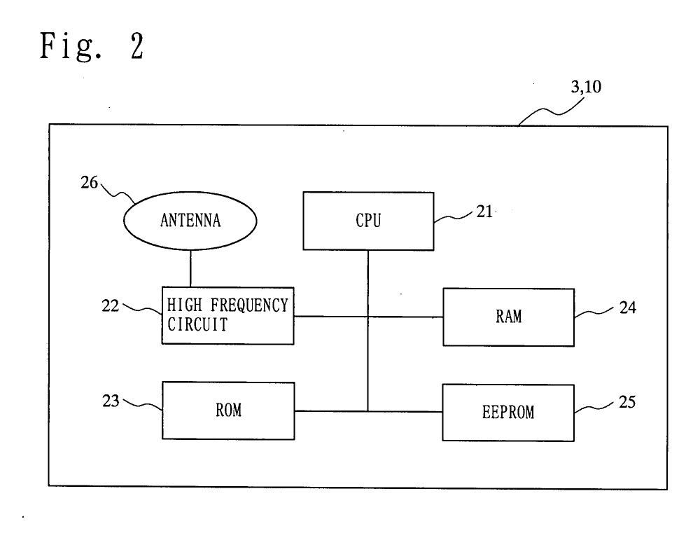

FIG. 2 is a block diagram showing an example of the hardware configuration of a non-contact IC card which constitutes the campaign card 3 or the electronic money card 10. In this way, the campaign card 3 and the electronic money card 10 have fundamentally the same hardware configuration. Here, the electronic money card 10 will be described as an example.

As shown in the figure, the electronic money card 10 used in the present embodiment incorporates a CPU (Central Processing Unit) 21, a high frequency circuit 22, an antenna 26, an ROM (Read Only Memory) 23, an RAM (Random Access Memory) 24, an EEPROM (Electrically Erasable and Programmable ROM) 25, and the like.

These elements are formed on the IC chip embedded in the electronic money card 10. However, the antenna 26 is formed from an aerial wire set near the outer edge part inside the electronic money card 10, and its end is connected to the IC chip.

The CPU 21 is a central processing unit for performing information processing according to the program stored in the ROM 23 and the EEPROM 25. In the present embodiment, the electronic money card 10 performs communication processing with the charge terminal 2 or the electronic money terminal through the reader/writer section, updates the amount of money of the currently stored value by using the amount-of-money update information inputted from these terminal apparatuses, outputs the current value balance, or the like. When the program for value processing is executed by the CPU 21, the value processing section 14 (FIG. 1B) is set up.

The antenna 26 is an antenna for performing short-range wireless communications with the antenna incorporated in the reader/writer section. The electronic money card 10 performs wireless communications while obtaining drive electric power from the reader/writer section through the antenna 26 by radio.

The high frequency circuit 22 converts a high frequency wave transmitted from the reader/writer section to the antenna 26 into a digital signal to output to the CPU 21, and on the contrary, it converts a digital signal outputted from the CPU 21 into a high frequency wave and outputs to the antenna 26 to transmit to the reader/writer section.

The RAM 24 is an optionally writable/readable memory which provides a working memory when the CPU 21 performs information processing. The RAM 24 can hold memory contents while electric power is supplied to the electronic money card 10, but the memory contents will be lost when the supply of the electric power is stopped.

The ROM 23 is a read-only memory for storing a fundamental program, parameters, data, or the like for operating the electronic money card 10. These information are beforehand fixed in the ROM 23 and writing or erasing information again may not usually be performed.

The EEPROM 25 is an ROM allowing information to be written or erased. The information stored in the EEPROM 25 is maintained even without the supply of electric power to the electronic money card 10. As described above, the ROM 23 and the EEPROM 25 constitute a program/data memory domain of the electronic money card 10.

The EEPROM 25 stores an OS (Operating System) which is a fundamental program for operating the electronic money card 10, a value processing program for performing processing about value, such as updating the amount of money of value based on the amount-of-money update information or offering the current value balance, the current value balance, the log data of value, and the like. Moreover, the electronic money card ID which is ID information proper to the electronic money card 10 is also stored in the EEPROM 25. The electronic money card ID is used to manage the electronic money card 10. In addition, the memory section 16 (FIG. 1B) is formed from the EEPROM 25.

The hardware configuration of the non-contact IC card was described above using the electronic money card 10, and the campaign card 3 is also formed from a similar hardware. In the case of the campaign card 3, the campaign card ID is stored in the EEPROM 25, which is used to provide the campaign card ID for the charge terminal 2.

Moreover, the campaign card 3 and the electronic money card 10 each can be also formed from a contact IC card. In this case, the charge terminal 2 is provided with a contact terminal for accessing the contact IC card without using the reader/writer section.

Meanwhile, the contact IC card is also provided with a contact terminal, through which communications are made. In the hardware configuration of the contact IC card, the antenna 26 and the high frequency circuit 22 in FIG. 2 is replaced with an interface with the contact terminal.

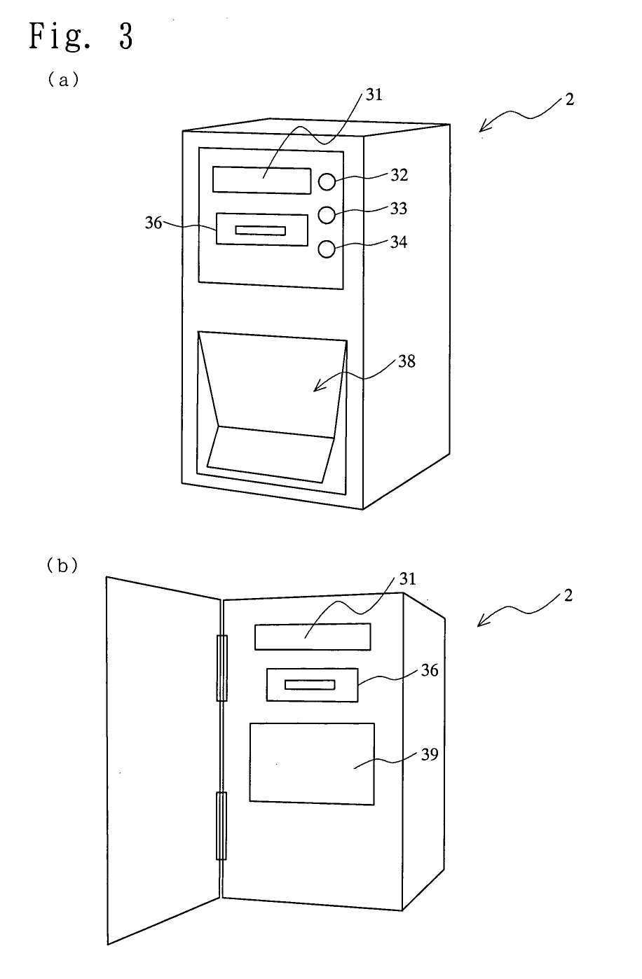

The charge terminal 2 will be now described. The charge terminal 2 constitutes the amount-of-money processing apparatus. FIG. 3A is a diagram illustrating the appearance of the charge terminal 2. The charge terminal 2 has a rectangular parallelepiped form, and a display operation section 31, a paper money inserting slot 36, a payment button 32, a cancellation button 33, a receipt button 34, and the reader/writer section 38 are formed in the front panel.

The display operation section 31 is provided with a display such as, for example, a liquid crystal display, and displays characters, signs, or the like. The display operation section 31 can instruct a user to “set an electronic money card,” “insert paper money,” or the like.

Moreover, the charge terminal 2 has the campaign mode other than the normal mode as the usual charge-only terminal, and the campaign company can perform various kinds of setup such as operation in the campaign mode while referring to the display of the display section.

The paper money inserting slot 36 is an slot for inserting paper money. The paper money inserting slot 36 is provided with a slit-like opening, and when a part of paper money is inserted in the opening, the paper money is automatically taken in the charge terminal 2 by a mechanism such as a roller. Moreover, in the case where the money paper is abnormal, the charge is stopped, or the like, the paper money once taken in is returned back from the paper money inserting slot 36.

The payment button 32 is a button for charging to the electronic money card 10 set to the reader/writer section 38. The amount of money to be charged is the amount of money of the paper money inserted in the normal mode, and is the amount of money set up with the campaign card 3 in the campaign mode.

The cancellation button 33 is a button for ending processing on the way. When the cancellation button 33 is pushed, the processing being performed by the charge terminal 2 is canceled at the time, and the charge terminal 2 returns to the initial state.

The receipt button 34 is a button for issuing a receipt. When the receipt button 34 is pushed after the use charges, a receipt is outputted from the receipt output port (not shown) provided in the upper part of the reader/writer section 38.

Incidentally, in the campaign charge, two receipts are outputted. One of these is for being affixed to a document and the other is for being kept by the user. It is stipulated on the receipt that the charge has been made by the campaign charge. Although on campaign a user may be required to fill out personal information, such as a name and an address, in a predetermined form and to affix the receipt of campaign charge, they are appropriately processed by issuing two receipts in this way.

The lower half part of the front panel of the charge terminal 2 has a concave portion depressed toward the inside of the charge terminal 2, and the reader/writer section 38 is provided in the flat section at the lower end of the concave portion. The reader/writer section 38 houses the reader/writer, and the campaign card 3 or the electronic money card 10 is put on this concave portion, so that wireless communications is performed between the charge terminals 2 and the card.

Incidentally, some mobile phones have a built-in IC chip for the use of value, and in this case, setting the mobile phone to the concave portion allows the charging in a manner similar to that of the electronic money card 10.

FIG. 3B shows an internal panel exposed by opening the front panel of the charge terminal 2. The left end section of the front panel is mounted with the main part by a hinge, allowing the front panel to be opened and closed. Incidentally, the front panel has a key portion which is not shown, and can be locked using the key so as not to be opened.

In the internal panel, the display operation section 31 and the paper money inserting slot 36 are formed, and in addition, a safe door 39 is formed. The safe door 39 is opened to retrieve the paper money inserted by users. Moreover, the internal panel is provided with a main power supply switch, a printer for printing a receipt, and the like, which are not shown.

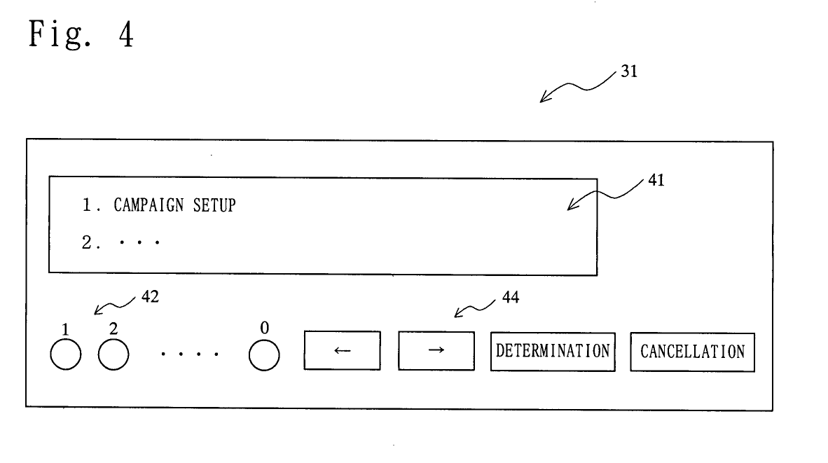

FIG. 4 shows the display operation section 31 exposed when the front panel is opened. The display operation section 31 is provided with a display 41, an input button 42, a function button 44, another function button which is not shown, and the like.

Incidentally, the display operation section 31 is configured so that when the front panel is closed, only the display 41 can be seen from the outside and neither the input button 42 nor the function button 44 can be touched from the outside. The campaign agency operates the various keys of the display operation section 31 to perform the setup of the amount-of-money table, or the like.

The display 41 displays various kinds of menu screens and an input screen. The example of FIG. 4 shows the screen of “1. Campaign setup, 2. . . . ,” and when the number is selected according to the menu screen, the selected function is performed.

The input button 42 is composed of a group of buttons with assigned numbers from 1 to 0, and various kinds of setup can be made by pushing these buttons according to the display of the display 41.

The function button 44 is composed of an arrow button, a determination button, a cancellation button, and the like. The arrow button is used to, for example, move a cursor displayed on the display 41. The determination button is pushed when the inputted information is decided and the cancellation button is pushed when the inputted information is cancelled.

It should be noted that when operation in the campaign mode is set, the input of a password is required. (As described above, the charge terminal 2 is provided with the password reception means.) In the present embodiment, in order to strengthen security, the password was set up not to be fixed but to be dynamically generated as follows.

The charge terminal 2 obtains an initial value by a predetermined logic (initial value obtaining means). Thus, the charge terminal 2 is provided with initial value updating means for automatically updating an initial value according to a predetermined rule.

The charge terminal 2 then calculates the initial value by the predetermined logic to generate a password. The logic is kept secret from a third party, and the third party cannot generate the password. The charge terminal 2 is provided with password comparison means for comparing whether the received input password and the generated password satisfy the predetermined relation (for example, whether they are the same), and when the passwords satisfy the predetermined relation, the setup of the amount-of-money table is accepted.

Meanwhile, a campaign sponsor obtains the password to be inputted into the campaign card 3 as follows. To the campaign sponsor, the password generation program is issued from an electronic money company in advance and is performed with a personal computer or the like.

When a password generation program is executed, an initial value and a password are generated by the same logic as the charge terminal 2 so that the password is outputted. Thus, the campaign sponsor can know the password calculated at the charge terminal 2.

Incidentally, when the password generation program is installed, it is necessary to obtain consent from the electronic money company in advance and to ask the electronic money company to issue the password needed for installation, and therefore the campaign sponsor cannot freely copy it to other computers.

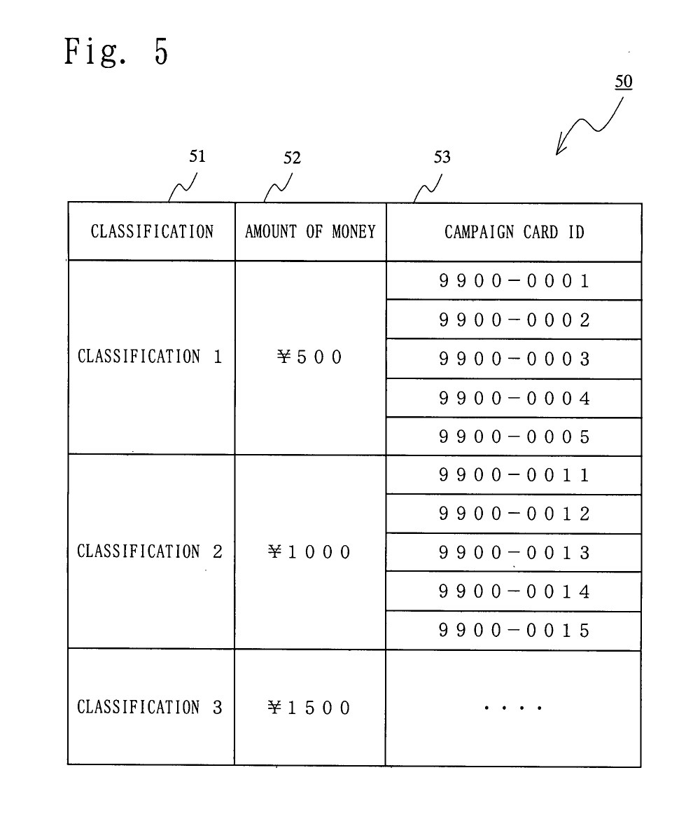

FIG. 5 is a diagram showing an example of the logical constitution of the amount-of-money table stored in the charge terminal 2. An amount-of-money table 50 is stored in a storage device with which the charge terminal 2 is provided. The amount-of-money table 50 is composed of a classification area 51, an amount-of-money area 52, and a campaign card ID area 53.

The classification area 51 is an area for setting up the classification of campaign. In the example of FIG. 5, three kinds, i.e., “classification 1,” “classification 2,” and “classification 3,” can be set up. Moreover, although in FIG. 5 only one amount-of-money table 50 is shown, the charge terminal 2 can be also configured so that a plurality of amount-of-money tables 50 are set up.

The amount-of-money area 52 is an area for setting up the amount of money for performing campaign charge in each classification. In the example of FIG. 5, 500 yen for “classification 1,” 1,000 yen for “classification 2,” and 1,500 yen for “classification 3” are set up.

The campaign card ID area 53 is an area for registering campaign card IDs corresponding to each classification and can register up to five campaign cards to one classification. In the example of FIG. 5, the campaign card IDs from “9900-0001” to “9900-0005” for “classification 1” and the campaign card IDs from “9900-0011” to “9900-0015” for classification 2” are registered.

Using the amount-of-money table 50 formed in this way, the charge terminal 2 can connect the campaign card ID of the campaign card set to the reader/writer section 38 with the amount of money for performing campaign charge. Moreover, the amount-of-money table 50 constitutes additional amount-of-money memory means for storing the campaign card ID as identification information and each amount of money as the additional amount of money.

The contents currently recorded in the amount-of-money table 50 can be newly prepared or be edited via the display operation section 31 and therefore the campaign sponsor can set up a value suitable for the contents of campaign.

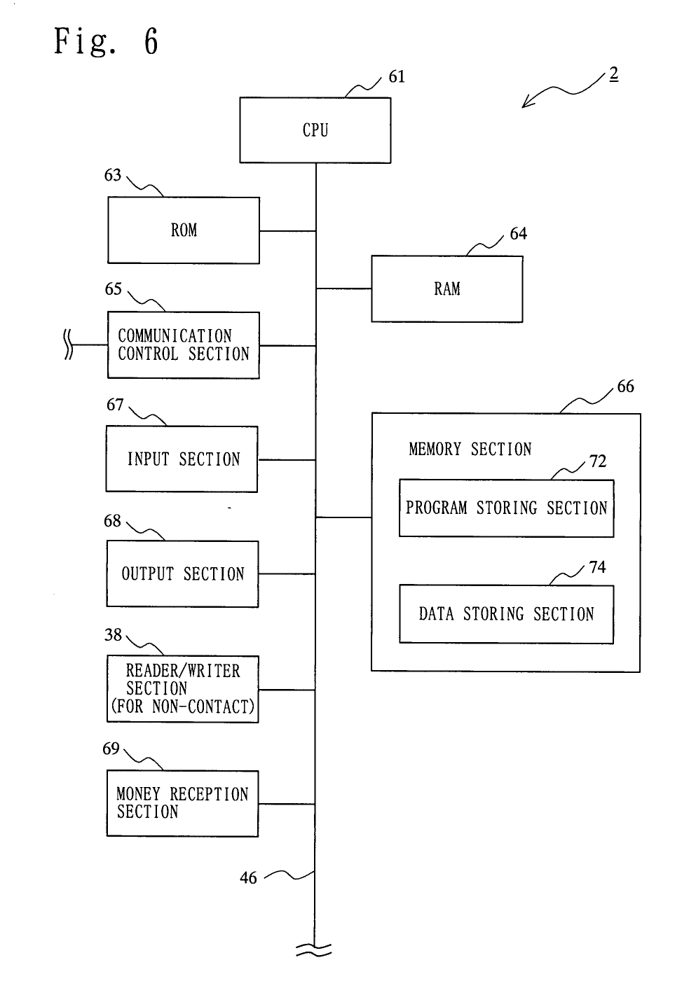

FIG. 6 is a diagram showing an example of the hardware configuration of the charge terminal 2. As shown in FIG. 6, the charge terminal 2 is composed of a CPU 61, an ROM 63, an RAM 64, a communication control section 65, a memory section 66, an input section 67, an output section 68, the reader/writer section 38, a money reception section 69, and the like, which are connected by a bus line 46.

The CPU 61 performs information processing according to a predetermined program and also the control of the whole charge terminal 2. In the present embodiment, in addition to the usual charge processing for inputting cash, the campaign charge processing using the campaign card 3 and a reception processing for setting up the amount-of-money table are also performed.

The ROM 63 is a read-only memory in which a fundamental program, parameters, or the like for operating the charge terminal 2 are stored. The RAM 64 is an optionally writable/readable memory which provides a working memory of the CPU 61, and loads and stores a program and data stored in the memory section 66.

The communication control section 65 is a connection device for connecting the charge terminal 2 to a network, and the charge terminal 2 transmits log data to an electronic money server managed by the electronic money company through the communication control section 65. Incidentally, the log is accumulated in a removable storage medium, and by using a technique such as retrieving the medium, the charge terminal 2 can be used in the environment without the use of networks.

The memory section 66 is composed of, for example, a storage medium including a semiconductor storage device, a hard disk, a magnetic storage medium, or the like, and a driver for driving these, and is composed of a program storing section 72 in which various programs are stored, a data storing section 74 in which data is stored, and the like.

In the program storing section 72, an OS which is a fundamental program for operating the charge terminal 2, a program for operating the CPU 61 in the normal mode or the campaign mode, a program for generating a password, or the like are stored. Moreover, in the data storing section 74, the amount-of-money table 50 and data such as log data at the time of processing the campaign card 3 or the electronic money card 10 are stored.

The input section 67 is provided with input devices, such as a display operation section 31 (buttons), the payment button 32, the cancellation button 33, the receipt button 34, and the like, to receive the input of information from the outside.

The output section 68 is provided with output devices, such as a printer for printing a receipt, and the display operation section 31 (display 41). Incidentally, the printer issues the above-mentioned receipt of campaign charge to the user, and in addition issues the total receipt on the day (bundle receipt) to the campaign sponsor. On the bundle receipt, the number of charging and the amount of money classified according to the charge by cash or the campaign charge are printed.

The money reception section 69 is provided with the paper money inserting slot 36 to receive the insertion of the paper money from the outside. The money reception section 69 judges whether or not the paper money is genuine, and further reads the face value of paper money with an optical device or the like. The reader/writer section 38 is the same as above-mentioned.

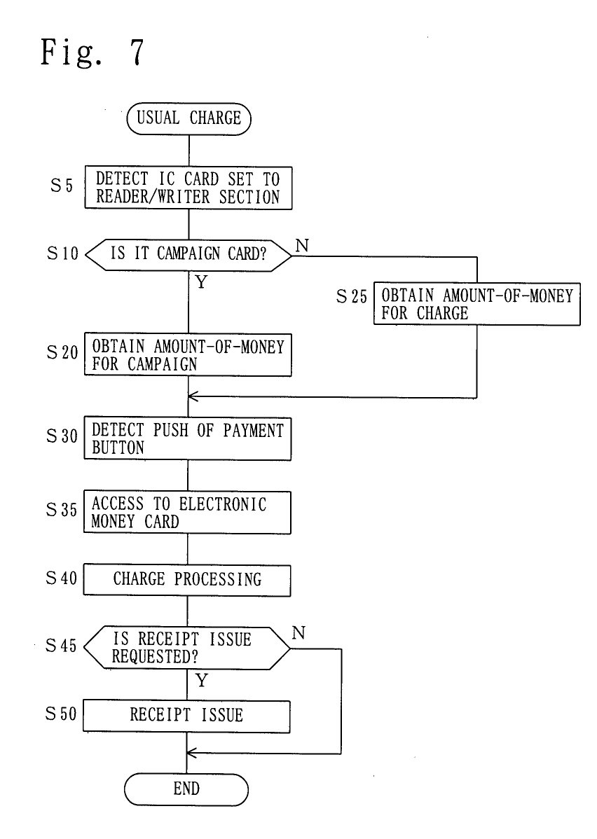

FIG. 7 is a flow chart illustrating the procedure of campaign charge performed by the charge terminal 2. First, the charge terminal 2 detects a non-contact IC card set to the reader/writer section 38 (Step 5). The charge terminal 2 then determines whether the non-contact IC card is the campaign card 3 or the electronic money card 10 (Step 10).

The determining method can include various methods, such as a method in which the non-contact IC card is judged as the campaign card 3 in the case where after it is determined whether or not the ID information read from the non-contact IC card is the same as the campaign card ID registered in the amount-of-money table, they are the same. Alternatively, in the non-contact IC card, the information on acknowledgement that it is the campaign card 3 is stored, and can be detected to judge the kind of card.

When the non-contact IC card set to the reader/writer section 38 is not the campaign card 3 (Step 10; N), the charge terminal 2 is operated in the normal mode, receives the insertion of paper money from the paper money inserting slot 36, and obtains the amount of money for charge (Step 25).

When the non-contact IC card set to the reader/writer section 38 is the campaign card 3 (Step 10; Y), the charge terminal 2 is operated in the campaign mode, compares the campaign card ID obtained from the campaign card 3 with that in the amount-of-money table, and obtains the corresponding amount of money for charge (Step 20). As described above, the charge terminal 2 is provided with identification information inputting means for receiving the input of identification information (campaign card ID) in the reader/writer section 38, and additional amount-of-money obtaining means for obtaining the additional amount of money by using the amount-of-money table 50.

In the above manner, after obtaining the amount of money for charge, the charge terminal 2 waits for the payment button 32 to be pushed. During this period, the campaign card 3 set to the reader/writer section 38 is taken out by the person in charge, and instead the electronic money card 10 is set.

The charge terminal 2, when detecting the push of the payment button 32, accesses the electronic money card 10 (Step 35) to perform the charge processing (Step 40). The charge processing is carried out by the procedure in which the charge terminal 2 communicates with the electronic money card 10 (money terminal communicating means) and outputs the amount-of-money update information to the electronic money card 10 (amount-of-money update information outputting means), and the electronic money card 10 updates the value balance according to the amount-of-money update information. Moreover, it generates sound effects when charging, and so on.

After finishing the charge processing, the charge terminal 2 monitors whether the receipt button 34 is pushed for a given time. When a receipt issue is requested (Step 45; Y), that is, the receipt button 34 is pushed within the given time, the charge terminal 2 issues two receipts (Step 50), and the charge terminal 2 completes the processing.

When a receipt issue is not requested (Step 45; N), that is, the receipt button 34 is not pushed within the given time, the charge terminal 2 completes the processing. Incidentally, it can be configured so that receipts are issued regardless of whether or not the receipt button 34 is pushed.

Moreover, in the case where the charge is performed in the campaign mode, after charging the electronic money card 10, it returns to the normal mode. Furthermore, at the time of charging, the charge terminal 2 collects information including the electronic money card ID, the campaign card ID, the amount of money for charge, time, and the like, and stores it as log data.

In the above manner, the charge terminal 2 can perform the campaign charge to the electronic money card 10 by using the campaign card 3. Incidentally, the campaign charge can be also performed by setting the mobile phone supporting the electronic money to the reader/writer section 38.

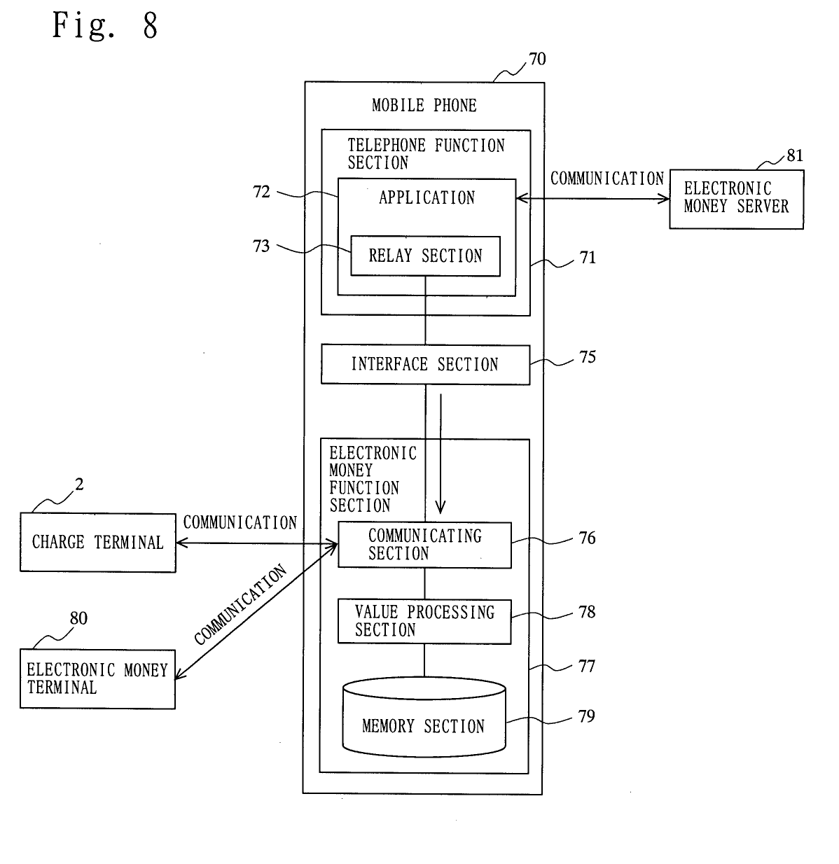

A mobile phone supporting the electronic money will be now described. FIG. 8 is a block diagram showing an example of the functional configuration of a mobile phone. As shown in FIG. 8, the mobile phone 70 is composed of a telephone function section 71 performing a function as a mobile phone which can be connected with the Internet, an electronic money function section 77 which is formed from the non-contact IC chip similar to that incorporated in the electronic money card 10 and performs the value processing function, and an interface section 75 for connecting both sections. The mobile phone 70 can perform the electronic money processing function similar to that of the electronic money card 10 by the electronic money function section 77.

The telephone function section 71 can perform wireless communications with a base station of the mobile phone 70 to connect with a telephone line network through the base station (for telephone call), or to connect with a server apparatus, such as an electronic money server 81, through the Internet. An application 72 is installed in the telephone function section 71. The application 72 is an application which provides the various services about the electronic money, and is provided with the relay section 73 which accesses the electronic money function section 77 through the interface section 75.

The application 72 has a function to provide a user with the information stored in the electronic money function section 77, for example, accessing the electronic money function section 77 to display an electronic money card ID, the value balance, log data, or the like, on a display.

Furthermore, the application 72 also communicates with the electronic money server 81 through the Internet. As a result of this, the electronic money card ID, the value balance, or the like stored in the electronic money function section 77 can be transmitted to the electronic money server 81, or the amount-of-money update information transmitted from the electronic money server 81 can be inputted into the electronic money function section 77.

Although not shown, the electronic money function section 77 is formed, in a manner similar to that of the electronic money card 10, from a non-contact IC chip formed from a CPU, an ROM, an RAM, an EEPROM, and a high frequency circuit, and an antenna, and a predetermined program is executed by the CPU to thereby form the communicating section 76, the value processing section 78, and the memory section 79.

The memory section 79 stores the electronic money card ID, the value balance, the log data, or the like. According to instructions from an external communication destination, the value processing section 78 outputs the electronic money card ID and the value balance, or receives the amount-of-money update information from the external communication destination to update the value balance. The communicating section 76 performs short-range wireless communications with the communication destination through the reader/writer section of the communication destination (the charge terminal 2, the electronic money terminal 80, or the like).

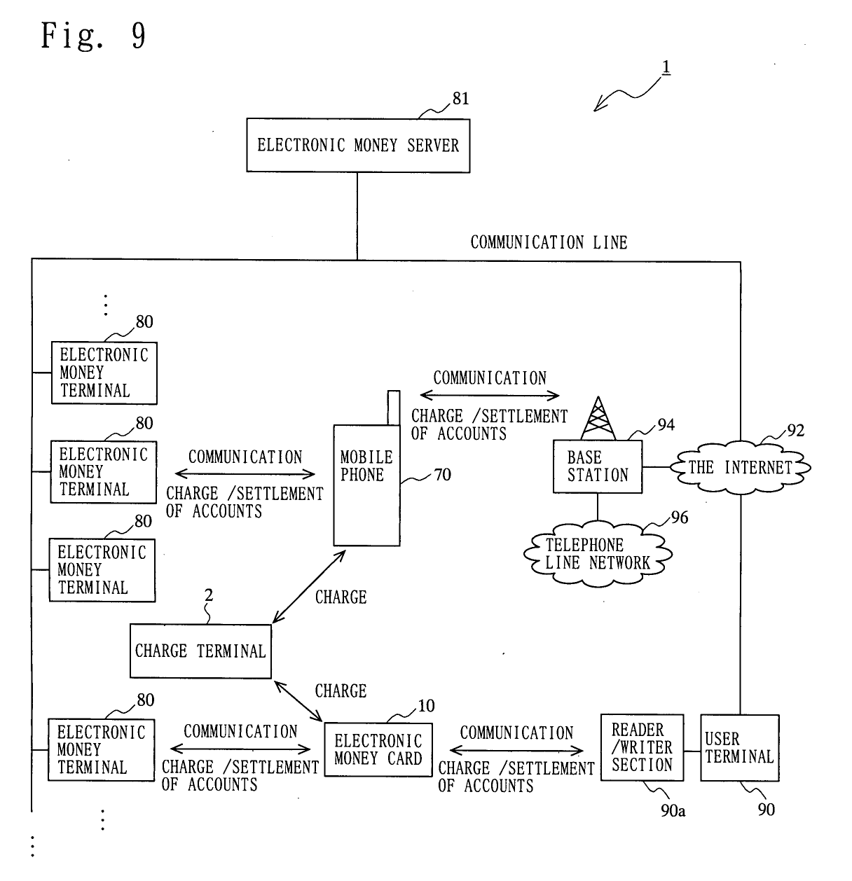

FIG. 9 is a diagram illustrating the usage patterns of the electronic money card 10 and the mobile phone 70 in an electronic money system. After the electronic money card 10 and the mobile phone 70 are charged, they are used in the electronic money system 1 shown in FIG. 9. The electronic money system 1 is composed of the electronic money server 81, the Internet 92, a base station 94, a telephone line network 96, electronic money terminals 80, 80, 80 and so on, a user terminal 90, and the like.

The electronic money terminal 80 is a terminal apparatus for non-contact IC card access placed in a store or the like, and is a special-purpose apparatus designed for electronic money business. Usually, the electronic money terminal 80 also serves as a cash register, and can deal with both cash and value.

The electronic money terminal 80 is provided with the reader/writer section with a built-in antenna, and it can perform short-range wireless communications with the non-contact IC chip embedded in the money terminal such as the electronic money card 10 or the mobile phone 70 by transmitting and receiving an electric wave with this antenna.

The electronic money terminal 80 can perform wireless communications with the electronic money card 10 and the mobile phone 70 to read these ID information and value balances, or to increase or decrease the amount of money of the stored value by inputting the amount-of-money update information.

Incidentally, although the charge terminal 2 is used to increase the value, but not to reduce the value, the electronic money terminal 80 can also reduce the value stored in the electronic money card 10 and the mobile phone 70. This allows the settlement of accounts by using value.

Moreover, although the present embodiment described the case of performing the campaign charge by using the charge terminal 2, it can be also configured to perform the campaign charge by using the electronic money terminal 80.

When the campaign charge is performed by the electronic money terminal 80, the amount-of-money table connecting the campaign card ID of the campaign card 3 with the amount of money for charge is stored in the electronic money terminal 80 in a manner similar to that of the charge terminal 2, and the campaign charge is performed to the electronic money card 10 in a manner similar to that of the charge terminal 2.

The user terminal 90 is, for example, a terminal apparatus composed of a personal computer or the like, and can be connected to the electronic money server 81 through the Internet 92. Moreover, the user terminal 90 is provided with the reader/writer section 90a as a peripheral, and can be used to perform short-range wireless communications with the electronic money card 10 and the mobile phone 70.

Accordingly, the user connects the electronic money card 10 or the mobile phone 70 to the user terminal 90 through the reader/writer section 90a, and the user terminal 90 is further connected to the electronic money server 81, so that the electronic money card 10 or the mobile phone 70 can be connected to the electronic money server 81. As a result of this, the electronic money server 81 can increase or reduce the value to the electronic money card 10 or the mobile phone 70. Moreover, in the case of the mobile phone 70, it can also connect to the electronic money server 81 through the base station 94. Incidentally, the telephone line network 96 is a network used for a telephone call by the mobile phone 70.

Thus, the electronic money system 1 serves as a distribution system for circulating value in a manner similar to that of the money, and a user can use the value charged in the electronic money card 10 or the mobile phone 70 by campaign, for the purchase of goods or service.

### (Modification)

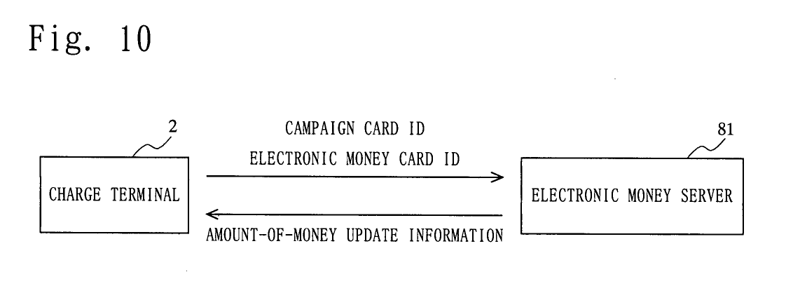

In the embodiment described previously, while the charge terminal 2 is a stand-alone apparatus, in the present modification, the charge terminal 2 is connected to the electronic money server 81 through a network, so that campaign charge is performed. FIG. 10 is a block diagram illustrating an modification. In the present modification, the charge terminal 2 and the electronic money server 81 are networked by the Internet or the like.

The procedure in which a user performs campaign charge at the charge terminal 2 is the same as that in the embodiment. Specifically, first, a person in charge sets the campaign card 3 to the charge terminal 2, and then a user charges by setting the electronic money card 10 to the charge terminal 2.

Meanwhile, the charge terminal 2 and the electronic money server 81 perform information processing as follows. When the campaign card 3 is set, the charge terminal 2 reads the campaign card ID to transmit to the electronic money server 81. The electronic money server 81 stores the amount-of-money table, which is used to obtain the amount of money for charge.

Next, when the electronic money card 10 is set, the charge terminal 2 reads the electronic money card ID to transmit to the electronic money server 81. If needed to generate the amount-of-money update information, the charge terminal 2 further obtains the value balance of the electronic money card 10 to transmit to the electronic money server 81. The electronic money server 81 receives the electronic money card ID from the charge terminal 2, and can specify the electronic money card 10 to be charged.

When specifying the electronic money card 10 to be charged, the electronic money server 81 generates the amount-of-money update information for charging according to the amount of money for charge obtained previously, and then transmits it to the charge terminal 2. The charge terminal 2 charges the electronic money card 10 by using this amount-of-money update information.

In the above manner, the charge terminal 2 and the electronic money server 81 can be also connected each other by a network to collaboratively perform campaign charge. Incidentally, the identification information associated with the campaign card ID can be printed on a campaign paper in the form of the bar code, and it can be also configured so that this is read by the bar code reader of the charge terminal 2 to be transmitted to the electronic money server 81.

Up to this point, the present embodiment and the modification were described, but further various modifications may be made. For example, instead of the campaign card 3, there can be used storage media storing identification information which can be connected with the amount-of-money table 50, such as a card with a magnetic stripe storing identification information, a bar code containing identification information, or the like.

The following effects can be obtained according to the above embodiment and modification:
(1) Charge processing can be prepared only by accessing the campaign card 3 and the charge terminal 2;
(2) The use of the amount-of-money table 50 allows any fractional amount of money other than the amount of money of paper money to be set up;
(3) The amount-of-money table 50 can be set up so as to match with each contents of campaign; and
(4) Since the password permitting access to the amount-of-money table 50 is dynamically generated, a high security level can be maintained.

1. An amount-of-money processing apparatus comprising:
additional amount-of-money memory means for setting up and storing a connection between identification information and an additional amount of money;
identification information inputting means for receiving an input of identification information;
additional amount-of-money obtaining means for obtaining the additional amount of money corresponding to the identification information whose input was received, by using the stored connection;
money terminal communicating means for communicating with a money terminal, including money information memory means for storing money information which expresses the amount of money of money value as electronic data, and amount-of-money updating means for updating the amount of money expressed by the stored money information by using amount-of-money update information; and
amount-of-money update information outputting means for outputting the amount-of-money update information for updating from the amount of money of the money information stored in the money terminal being communicating to the amount of money added by the obtained additional amount of money, to the money terminal.

2. The amount-of-money processing apparatus according to claim 1, comprising storage medium access means for accessing a storage medium storing identification information,
wherein the identification information inputting means obtains the identification information from the accessed storage medium to receive the input.

3.-4. (canceled)

5. In a computer provided with additional amount-of-money memory means, identification information inputting means, additional amount-of-money obtaining means, money terminal communicating means, and amount-of-money update information outputting means, an amount-of-money processing method comprising the steps of:
by the additional amount-of-money memory means, setting up and storing a connection between identification information and an additional amount of money;
by the identification information inputting means, receiving an input of the identification information;
by the additional amount-of-money obtaining means, obtaining the additional amount of money corresponding to the identification information whose input was received, by using the stored connection;
by the money terminal communicating means, communicating with a money terminal including money information memory means for storing money information which expresses the amount of money of money value as electronic data, and amount-of-money updating means for updating the amount of money expressed by the stored money information by using amount-of-money update information; and
by the amount-of-money update information outputting means, outputting the amount-of-money update information for updating from the amount of money of the money information stored in the money terminal being communicating to the amount of money added by the obtained additional amount of money, to the money terminal.
